(19) United States
(12) Patent Application Publication
(10) Pub. No.: US 2025/0099989 A1
(43) Pub. Date: Mar. 27, 2025

(54) ELECTROSTATIC SPRAYING EQUIPMENT AND ELECTROSTATIC SPRAYING METHOD

(71) Applicants: JIANGXI WONDERFUL CERAMICS CO., LTD., Yichun, Jiangxi (CN); FOSHAN CITY SANSHUI DISTRICT GUANGSHUN AUTOMATIC EQUIPMENT CO., LTD., Foshan, Guangdong (CN); DONGGUAN CITY WONDERFUL CERAMICS INDUSTRIAL PARK CO., LTD., Dongguan, Guangdong (CN); JIANGXI HEMEI CERAMICS CO., LTD., Yichun, Jiangxi (CN); MARCOPOLO HOLDINGS CO., LTD., Dongguan, Guangdong (CN)

(72) Inventors: Yuezeng XIE, Dongguan (CN); Jiaqi HUANG, Dongguan (CN); Zhichuan CHEN, Yichun (CN); Jianjun JIANG, Foshan (CN); Yucheng LIN, Dongguan (CN); Zhanwen GU, Yichun (CN); Yongguang JIANG, Yichun (CN); Shenghong CHEN, Dongguan (CN)

(73) Assignees: JIANGXI WONDERFUL CERAMICS CO., LTD., Yichun, Jiangxi (CN); FOSHAN CITY SANSHUI DISTRICT GUANGSHUN AUTOMATIC EQUIPMENT CO., LTD., Foshan, Guangdong (CN); DONGGUAN CITY WONDERFUL CERAMICS INDUSTRIAL PARK CO., LTD., Dongguan, Guangdong (CN); JIANGXI HEMEI CERAMICS CO., LTD., Yichun, Jiangxi (CN); MARCOPOLO HOLDINGS CO., LTD., Dongguan, Guangdong (CN)

(21) Appl. No.: 18/565,660

(22) PCT Filed: Feb. 23, 2023
(86) PCT No.: PCT/CN2023/078002

§ 371 Date: Nov. 30, 2023

(30) Foreign Application Priority Data
Dec. 7, 2022 (CN) 202211565241.1

(51) Int. Cl. B05B 5/16; B05B 5/04; B05B 5/08; B05B 15/52

(52) U.S. Cl. CPC B05B 5/16; B05B 5/04; B05B 5/08; B05B 15/52

(57) ABSTRACT

Electrostatic spraying equipment and an electrostatic spraying method. The electrostatic spraying equipment includes a glaze storage and adjustment device used for storing and stirring glaze, a transfer isolation device used for receiving the glaze in the glaze storage and adjustment device, an electrostatic rotary cup spray gun used for receiving the glaze in a transfer isolation glaze barrel and spraying the glaze to a body to be glazed on a glaze line, a PLC (programmable logic controller) intelligent controller connected with the glaze storage and adjustment device, the transfer isolation device and the electrostatic rotary cup spray gun, and a high-voltage electrostatic generator connected with the electrostatic rotary cup spray gun and used for electrifying the electrostatic rotary cup spray gun. The glaze is stored and stirred through the glaze storage and adjustment device.

### TECHNICAL FIELD

The present disclosure relates to the technical field of ceramic production, in particular to electrostatic spraying equipment and an electrostatic spraying method.

### BACKGROUND

In the existing technical scheme of applying bottom glaze to building ceramics, there are generally the following ways to spray bottom glaze.

The first way is that a glaze throwing cabinet or high-pressure automatic glaze spraying system is used for glazing. When the glaze throwing cabinet is used for glazing, the atomization capacity and implementation area are very limited, the general working specific gravity is lower than 1.40, and the maximum green body implementation area is difficult to exceed the specification of 800 mm*800 mm, and the glaze flatness is not ideal. The high-pressure automatic glaze spraying system can be used for large-area glazing of large ceramic plates, but the working specific gravity is generally lower than 1.55. Once the glazing amount is less than 300 g/m², the glaze flatness cannot meet the requirements.

The second way is glaze spraying. The biggest advantage of bell jar glaze spraying is that the specific gravity can exceed 1.70 so that the flatness is high and the moisture in kilns is relatively low. However, once the glaze spraying amount is less than 300 g/m², glazing is difficult, and glaze spraying is easy to break and bifurcate.

The third way is that a screen plate printing or rotary screen printing machine and a rubber roll printing machine are used for glazing. Specification problem is the biggest disadvantage of using these requirements. Once the specification exceeds 1.2 m, the accuracy of the equipment is difficult to meet the equipment. There are also great restrictions on the requirements of glaze line output and glazing amount. Generally, it is difficult to exceed the linear speed of 30 m/min, and many production defects such as mesh sticking, grid lines and water ripples are prone to occur. The grazing amount is difficult to exceed 80 g/m². This process requires high technical proficiency of operators, and additionally needs the processing and using links of glaze and the customization link of flat screens and rubber rolls.

The fourth way is that ink-jet printing is used for glazing. The digital glaze implemented in ink-jet printing is mainly oily ink, the working specific gravity is less than 1.40, and the glazing amount in a single channel is difficult to exceed 40 g/m². Ink-jet ink is high in cost due to the special requirements for oily solvents, additives and ink particle size, and the general unit price is between 30,000 and 120,000 per ton. Moreover, inkjet printing has many defects, such as glaze dropping and wire pulling, so that stable glazing is difficult to implement in a large area.

In conclusion, at present, thin-layer water-based glaze with the specific gravity of between 1.20 and 1.50 and the glaze amount of between 0 g/m² and 120 g/m² cannot be stably and evenly distributed on large-scale products of the traditional equipment in the building ceramic industry.

Therefore, the prior art has defects and needs to be improved and developed.

### SUMMARY

The technical problem to be solved by the present disclosure is that aiming at the defects in the prior art, the present disclosure provides electrostatic spraying equipment and an electrostatic spraying method, aiming at solving the problem that thin-layer water-based glaze cannot be stably and evenly distributed on large-scale products of the traditional equipment in the building ceramic industry in the prior art.

The technical scheme adopted for solving the technical problem of the present disclosure is as follows.

Electrostatic spraying equipment includes:
a glaze storage and adjustment device, the glaze storage and adjustment device being used for storing and stirring glaze;
a transfer isolation device, the transfer isolation device being connected with the glaze storage and adjustment device and used for receiving the glaze in the glaze storage and adjustment device;
an electrostatic rotary cup spray gun, the electrostatic rotary cup spray gun being connected with a transfer isolation glaze barrel and used for receiving the glaze in the transfer isolation glaze barrel and spraying the glaze to a body to be glazed on a glaze line;
a PLC (Programmable Logic Controller) intelligent controller, the PLC intelligent controller being connected with the glaze storage and adjustment device, the transfer isolation device and the electrostatic rotary cup spray gun; and
a high-voltage electrostatic generator, the high-voltage electrostatic generator being connected with the electrostatic rotary cup spray gun and used for electrifying the electrostatic rotary cup spray gun.

In an implementation method, the electrostatic rotary cup spray gun includes a gun barrel and a gun head which are connected with each other and mounted coaxially. An insulating gun holster sleeves the gun barrel. An insulating waterproof cap is arranged on the insulating gun holster.

In an implementation method, the glaze storage and adjustment device includes:
an isolation platform;
a glaze storage barrel, the glaze storage barrel being arranged on the isolation platform and used for storing glaze;
a first stirrer, the first stirrer being arranged in the glaze storage barrel and used for stirring the glaze in the glaze storage barrel;
a first conveying pump, the first conveying pump being arranged on the isolation platform and used for conveying the glaze to the transfer isolation glaze barrel;
a first discharge device, the first discharge device being arranged on the isolation platform and used for discharging static electricity generated by the glaze storage barrel;
a liquid level measuring device, arranged above the glaze storage barrel and used for measuring the liquid level of the glaze storage barrel;
the transfer isolation device includes:
an isolation workbench;
a transfer isolation glaze barrel, the transfer isolation glaze barrel being arranged on the isolation workbench and used for receiving the glaze conveyed by the first conveying pump;
a second conveying pipe, the second conveying pipe being connected with the transfer isolation glaze barrel and used for conveying the glaze to the electrostatic rotary cup spray gun;
a second stirrer, the second stirrer being arranged in the transfer isolation glaze barrel and used for stirring the glaze in the transfer isolation glaze barrel; and
a second discharge device, the second discharge device being arranged on the isolation workbench and used for discharging static electricity generated by the transfer isolation glaze barrel.

In an implementation method, the glaze storage barrel and the transfer isolation glaze barrel are made of PA insulating materials, and the isolation platform and the isolation workbench are made of ABS engineering plastics.

In an implementation further method, the transfer isolation device also includes:

a roller pump, the roller pump being connected with the second conveying pipe and used for supplying the glaze in the transfer isolation glaze barrel to the electrostatic rotary cup spray gun through the second conveying pipe, and the roller pump being connected with the PLC intelligent controller.

In an implementation method, the electrostatic spraying equipment also includes:
an electrostatic glaze spraying cabinet, the electrostatic rotary cup spray gun being arranged in the electrostatic glaze spraying cabinet;
a driving mechanism, the driving mechanism being arranged above the electrostatic glaze spraying cabinet, connected with the electrostatic rotary cup spray gun, and used for driving the electrostatic rotary cup spray gun to move, and the driving mechanism also being connected with the PLC intelligent controller; and
an air compressor, the air compressor being internally provided with a temperature and humidity control air conditioning control module and a full-automatic cleaning control module, the air compressor being used for providing a high-pressure air source and connected with the electrostatic rotary cup spray gun.

In an implementation method, the electrostatic glaze spraying cabinet includes an upper cabinet body and a lower cabinet body which can be detachably connected. The upper cabinet body is made of HDPE (High-Density Polyethylene) plastic insulating plastics, and the lower cabinet body is made of stainless steel.

In an implementation method, the electrostatic spraying equipment also includes:

a glaze recycle disc, the glaze recycle disc being arranged in the electrostatic glaze spraying cabinet and placed under the glaze line to recycle atomized glaze.

The present disclosure also provides a spraying method based on the electrostatic spraying equipment, including the following steps:
preparing all-water electrostatic working slurry;
conveying the all-water electrostatic working slurry to a transfer isolation device through a glaze storage and adjustment device;
starting a PLC intelligent controller and a high-voltage electrostatic generator, controlling an electrostatic rotary cup spray gun to swing for glazing according to working glazing amount;
after glazing, turning off the high-voltage electrostatic generator and discharging; and cleaning pipelines in the electrostatic spraying equipment.

In an implementation method, the step of preparing all-water electrostatic working slurry specifically includes the following steps:
determining a ball-milling formula of water-based glaze according to current temperature and humidity information, and throwing balls according to the ball-milling formula of water-based glaze to prepare original glaze;
determining an additive formula, adjusting parameters of the original glaze according to the additive formula to reach working physical and chemical indexes and working specific gravity, and obtaining the all-water electrostatic working slurry after sieving and removing iron;
the step of conveying the all-water electrostatic working slurry to a transfer isolation device through a glaze storage and adjustment device specifically includes the following steps:
conveying the all-water electrostatic working slurry to a glaze storage barrel of the glaze storage and adjustment device;
conveying the all-water electrostatic working slurry in the glaze storage barrel to a transfer isolation glaze barrel of the transfer isolation device;
the step of starting a PLC intelligent controller and a high-voltage electrostatic generator, controlling an electrostatic rotary cup spray gun to swing for glazing according to working glazing amount specifically includes the following steps:
starting a PLC intelligent controller, controlling an electrostatic rotary cup spray gun to swing according to preset swing amplitude and preset frequency;
conveying the all-water electrostatic working slurry to the electrostatic rotary cup spray gun through an electrostatic spray gun pipeline, and simultaneously carrying out glaze cabinet dust removal and internal pressure adjustment;
starting a high-voltage electrostatic generator, and carrying out temperature and humidity control, and adjusting the glazing amount of the electrostatic rotary cup spray gun to working glazing amount by adjusting the speed of a belt on a glaze line and the rotating speed of a roller pump on the transfer isolation device;
in the spraying process, according to different production process requirements, switching an automatic wetting cleaning mode, a full-automatic cleaning mode and a normal mode for rotary cup vanes by a full-automatic cleaning control module in an air compressor;
the step of cleaning pipelines in the electrostatic spraying equipment specifically includes the following steps:
replacing the glaze in the transfer isolation glaze barrel of the transfer isolation device into clean liquid, and starting the full-automatic cleaning mode to clean all pipelines; and turning off the roller pump on the transfer isolation device.

The present disclosure provides electrostatic spraying equipment and an electrostatic spraying method. The electrostatic spraying equipment includes a glaze storage and adjustment device used for storing and stirring glaze, a transfer isolation device connected with the glaze storage and adjustment device and used for receiving the glaze in the glaze storage and adjustment device, an electrostatic rotary cup spray gun connected with a transfer isolation glaze barrel and used for receiving the glaze in the transfer isolation glaze barrel and spraying the glaze to a body to be glazed on a glaze line, a PLC intelligent controller connected with the glaze storage and adjustment device, the transfer isolation device and the electrostatic rotary cup spray gun and used for controlling the glaze storage and adjustment device, the transfer isolation device and the electrostatic rotary cup spray gun, and a high-voltage electrostatic generator connected with the electrostatic rotary cup spray gun and used for electrifying the electrostatic rotary cup spray gun. The glaze is stored and stirred through the glaze storage and adjustment device. The glaze is conveyed to the electrostatic rotary cup spray gun by the transfer isolation device. Uniform atomization coating of all-water thin-layer glaze on a glazed body of a large-size product in the building ceramic industry is realized through the electrostatic rotary cup spray gun, so that the industrial technical problems of rotary cup glaze accumulation, glaze dropping in a glaze cabinet, dropping dirt and dropping slag and electric leakage when the traditional water-based electrostatic spraying industry is applied to the building ceramic field across industries are solved.

### BRIEF DESCRIPTION OF THE DRAWINGS

FIG. 1 a front view of electrostatic spraying equipment in a preferred embodiment of the present disclosure.

FIG. 2 is a top view of electrostatic spraying equipment in a preferred embodiment of the present disclosure.

FIG. 3 is a structural schematic diagram of an electrostatic rotary cup spray gun of electrostatic spraying equipment in a preferred embodiment of the present disclosure.

FIG. 4 a structural schematic diagram of three electrostatic rotary cup spray guns of electrostatic spraying equipment in a preferred embodiment of the present disclosure.

FIG. 5 is a structural schematic diagram of a glaze storage and adjustment device of electrostatic spraying equipment in a preferred embodiment of the present disclosure.

FIG. 6 is a structural schematic diagram of a first view of a transfer isolation device of electrostatic spraying equipment in a preferred embodiment of the present disclosure.

FIG. 7 is a structural schematic diagram of a second view of a transfer isolation device of electrostatic spraying equipment in a preferred embodiment of the present disclosure.

FIG. 8 is a wind power distribution diagram of a first view of glaze cabinet dust removal and glaze cabinet internal pressure adjustment of electrostatic spraying equipment in a preferred embodiment of the present disclosure.

FIG. 9 is a wind power distribution diagram of a second view of glaze cabinet dust removal and glaze cabinet internal pressure adjustment of electrostatic spraying equipment in a preferred embodiment of the present disclosure.

FIG. 10 is a switching schematic diagram of three modes such as an automatic wetting cleaning mode, a full-automatic cleaning mode and a normal mode for rotary cup vanes in the present disclosure.

Reference signs in attached figures:
100, glaze storage and adjustment device; 110, isolation platform; 120, glaze storage barrel; 130, first stirrer; 140, first conveying pump; 150, first discharge device; 160, liquid level measuring device; 200, transfer isolation device; 210, isolation workbench; 220, transfer isolation glaze barrel; 230, second stirrer; 240, second discharge device; 250, second conveying pipe; 260, roller pump; 261, driver; 300, electrostatic rotary cup spray gun; 310, gun barrel; 311, insulating gun holster; 312, insulating waterproof cap; 320, gun head; 330, connecting rod; 400, PLC intelligent controller; 500, high-voltage electrostatic generator; 600, electrostatic glaze spraying cabinet; 610, glaze cabinet dust removal device; 620, glaze cabinet internal pressure adjustment device; 700, driving mechanism; 800, air compressor; and 900, glaze recycle disc.

### DETAILED DESCRIPTION OF THE EMBODIMENTS

In order to make the objectives, technical solutions and advantages of the present disclosure clearer, the present disclosure will be further described with reference to the attached figures and embodiments thereof. It shall be understood that, the embodiments described herein are only intended to illustrate but not to limit the present disclosure.

At present, the traditional equipment and technical means in the building ceramic industry have the technical bottleneck that thin-layer water-based glaze with the specific gravity of between 1.20 and 1.50 and the glaze amount of between 0 g/m² and 120 g/m² cannot be stably and evenly distributed on large-scale products.

80% to 90% of automobile body coating spraying adopts rotary cup high-speed electrostatic spraying process, and excellent film performance and high coating effect can be obtained by using rotary cup high-speed electrostatic spraying. The coating market in China in mainly involved in light industry, household appliances, motorcycles, automobiles and other industries, but these industries mainly rely on experience and a large number of experiments to set parameters such as rotary cup speed, coating flow and flow rate. Because there are many influencing factors involved in the process of rotary cup high-speed electrostatic spraying, if various influencing factors are not reasonably selected and controlled in practical application, low electrostatic spraying quality may be caused. Especially when spraying environment and conditions change, the spraying environment and conditions change are difficult to redesign and analyze. Some automobile manufacturers (companies) spend millions or even tens of millions and take 4 to 5 years to build the coating line, but finally the coating line cannot be debugged. Sometimes, the coating line needs to be reformed after putting into production because of faults, resulting in a lot of manpower and material losses.

In the field of coating, water-based coatings have the characteristics of low resistance (usually the range of resistivity is lower than 1 MΩ·CM) and good electrical conductivity. A special coating isolation system with an insulation function must be set up in electrostatic coating. Specifically, water-based coating has the following methods to realize insulation:

The first method is total insulation of a supply system. That is, a robot, a pump and a tank are all insulated, and the method is mainly characterized by high equipment investment, difficult insulation of a gear pump (motor) and other equipment, and less application in actual production.

The second method is target spraying to increase the voltage directly. That is, the positive voltage is increased to a spraying target, the method is mainly characterized by large electrostatic capacity, danger and more particles attached to a spraying body, and the method is not applied in actual production.

The third method is external charging. That is, the voltage is increased from an external electrode to the sprayed coating particles, and the method is mainly characterized by high loss and low coating efficiency caused by indirect charging.

The fourth method is internal charging. That is, the supply system is cut off by physical means, and the method is characterized by high spraying efficiency and has related applications in actual production.

It is also necessary to solve the above problems when all-water electrostatic working slurry spraying is implemented in building ceramic industry, and generally speaking, the difficulty is also greater. In traditional coating applications, the spraying flow rate is generally small, the spraying linear speed is generally less than 5 m/min, and the number of rotary cups required is small. However, the spraying amount of a single spray gun is generally less than 20 g/m² according to the spraying amount per square meter. In the application end of building ceramic industry, the linear speed is usually greater than 20 m/min, and the glazed product is a large porcelain plate (1.62 m²/piece) with large specifications. The glazing amount needs to reach 0-120 g/m² in the process. Therefore, in the implementation process, 3 to 6 electrostatic rotary cup spray guns are needed. No matter whether the design of internal power or external power is adopted, these high-speed rotary cups are sprayed in a glaze cabinet for a long time, the following situations are easy to appear.

Firstly, because a spray atomization airflow sprays on the surface of a body, local airflow rebound occurs.

Secondly, due to limitation of the distance between electrostatic spray guns, different electrostatic atomized particles repel each other, resulting in extremely irregular airflow distribution in the glaze cabinet. After electrostatic atomization works for a period of time, the airflow is gradually accumulated on a gun barrel frame, a gun body, connecting wires, the glaze cabinet and other parts of an electrostatic rotary cup to form a continuous water film. Frequent leakage and electrostatic loss are easy to cause, thus affecting the atomization effect of the rotary cup and also causing local glaze dropping due to long-term accumulation.

Thirdly, the large fluctuation of atomized particle diameter affects the uniformity of a sprayed glaze layer and greatly affects the glazing effect, finally resulting in abnormal color, layout and performance indexes of a sintered product. Normal production cannot be ensured.

Moreover, when quick-drying water-based coatings are sprayed on traditional electrostatic rotary cups, the water-based electrostatic coatings are very easy to evaporate rapidly at high speed of the electrostatic rotary cups, resulting in crust and furr at the head of the rotary cup. The crust and furr are extremely difficult to clean, resulting in spraying defects, frequent cleaning, rework and line stoppage. The spraying efficiency of customers is greatly influenced. The fundamental reason for this phenomenon is that the coating is emitted to all sides by high-speed centrifugation of the rotary cup. At the same time, under the action of atomizing air and molding air, the coating is atomized into very small droplets (micron level) around the rotary cup, and most of droplets fly to the surface of an object and are adsorbed under the action of an electrostatic field. The remaining small droplets fly around, and some droplets can fall on the surface of the rotary cup. Compressed air through rotary cup atomization and molding passes through the surface of the rotary cup through internal pipelines of a gun body, and is intersected with the coating thrown out by high-speed centrifugation at the farthest end of the rotary cup. The compressed air collides with the high-speed rotary cup (usually the rotating speed is 30,000-40,000 rpm) to generate heat. Because the main component of the water-based coating is water, the droplets are quickly evaporated to lose water under the injection of the compressed air (0.1-0.4 mpa), and the remaining part of the coating is adhered to the surface of the rotary cup. The longer the working time, the thicker the coating residues adhered to the surface of the rotary cup are.

The boiling point of common ceramic water-based glaze is generally not higher than 100 degrees centigrade, and the above problems are extremely easy to occur. Under normal circumstances, the rotary cup speed exceeds 30,000 rpm, and serious glaze accumulation for spray head rotary vanes may occur in less than half an hour during practical work. Under continuous spraying with a long period of time and a high amount of glaze, the parts such as the gun body, connecting flanges and the top of the glaze cabinet may also cause crust, slag and dirt. Once the moisture retention of the glaze is improved, for example, when the boiling point is higher than 110 degrees centigrade, under continuous spraying with a long period of time and a high amount of glaze, the gun body, the connecting flanges, the top of the glaze cabinet and other parts may also cause glaze dropping, electric leakage and other phenomena. Therefore, on one hand, it is necessary to control the temperature and humidity in the spraying glaze cabinet, on the other hand, it is also necessary to control the formula characteristics of water-based glaze, and adjust the boiling point, atomization effect and glaze application amount of glaze. The difficulty in large-scale industrial production is extremely high.

In conclusion, the traditional equipment and technical means in the building ceramic industry have the technical bottleneck that thin-layer water-based glaze with the specific gravity of between 1.20 and 1.50 and the glaze amount of between 0 g/m² and 120 g/m² cannot be stably and evenly distributed on large-scale products. At the same time, there are still many technical bottlenecks when the electrostatic spraying is applied in the large-scale industrialization of building ceramic industry. Especially for electrostatic spraying technology of large-scale products, it is necessary to solve the production problems such as slow drying and glaze dropping, easy electric leakage, quick drying and glaze accumulation, crust and slag dropping, so that the production cost is reduced, and the excellent rate is improved.

By improving the structure and material of the traditional building ceramic glaze spraying cabinet, improving a gun body and gun rack connecting mechanism of the electrostatic rotary cup and optimizing the technical indexes of the all-water electrostatic working slurry and the technical parameters of the equipment, the distribution, flow quantity and drying evaporation rate of the atomized water-based glaze film in the spray gun rotary vanes, the gun body and gun rack connecting mechanism and the glaze spraying cabinet are effectively controlled, the industrial technical problems of rotary cup glaze accumulation caused by the high-speed rotation of the electrostatic rotary cup and quick glaze evaporation, glaze dropping of the glaze cabinet and easy electric leakage because of too large glazing amount in the traditional water-based electrostatic spraying cross-industry application are solved, and the industrial application effect of the electrostatic glaze spraying technology that an environmentally-friendly all-water thin-layer glaze with the glaze amount of 0 to 120 g/m² and the average atomized particle diameter D90 of less than 0.15 mm in the building ceramic industry for the first time is realized.

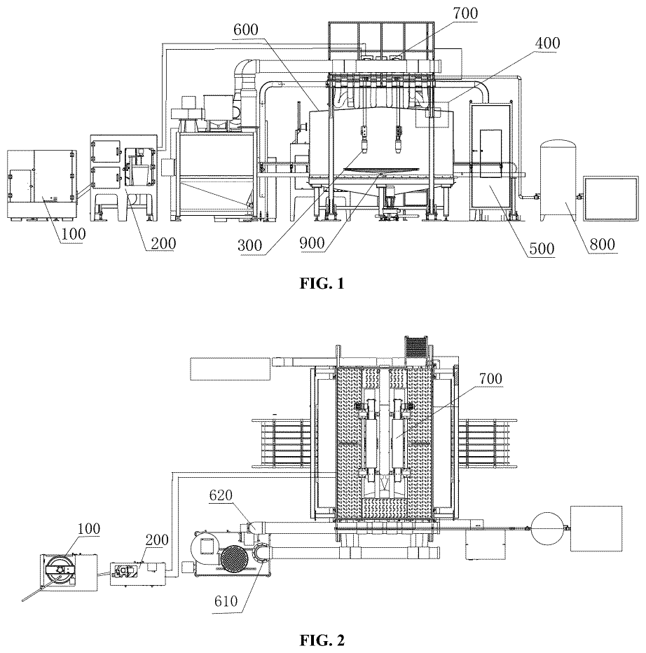

Referring to FIG. 1 and FIG. 2, the present disclosure provides electrostatic spraying equipment. The electrostatic spraying equipment includes a glaze storage and adjustment device 100, a transfer isolation device 200, an electrostatic rotary cup spray gun 300, a PLC intelligent controller 400 and a high-voltage electrostatic generator 500. The glaze storage and adjustment and adjustment device 100 is used for storing and stirring glaze. The transfer isolation device 200 is connected with the glaze storage and adjustment device 100 and used for receiving the glaze in the glaze storage and adjustment device 100 and adjusting the glaze according to adjustment index requirements. The electrostatic rotary cup spray gun 300 is connected with a transfer isolation glaze barrel 200 and used for receiving the glaze in the transfer isolation glaze barrel 220 and spraying the glaze to a body to be glazed on a glaze line. The PLC intelligent controller 400 is connected with the glaze storage and adjustment device 100, the transfer isolation device 200 and the electrostatic rotary cup spray gun 300. The PLC intelligent controller 400 is used for controlling the glaze storage and adjustment device 100, the transfer isolation device 200 and the electrostatic rotary cup spray gun 300. Two groups of spray guns are mainly controlled to swing left and right. The swing amplitude and frequency are digitally adjustable to ensure that the atomized glaze is uniformly distributed on the surface of the body. The high-voltage electrostatic generator 500 is connected with the electrostatic rotary cup spray gun 300 and used for electrifying the electrostatic rotary cup spray gun 300. The high-voltage electrostatic generator 500 generates high-voltage static electricity, so that the spray gun is charged through special cables and special trunks. The PLC intelligent controller 400 adopts a built-in voltage doubling automatic protection circuit design, thus effectively preventing a strong spark phenomenon caused by short-distance electric leakage. When the short-circuit leakage current of high-voltage electrostatic output reaches a set protection value, the machine is automatically protected and stops. The maximum leakage current is 100 μA and is far lower than the safety of human electric shock. At this time, it is necessary to restart the machine to rework, so that the safety of equipment operation and operation is effectively ensured.

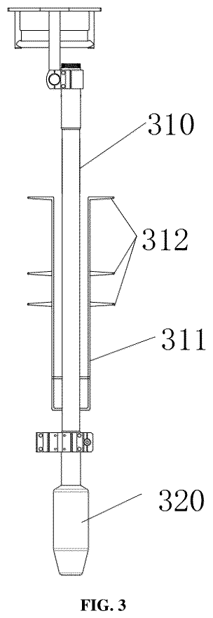

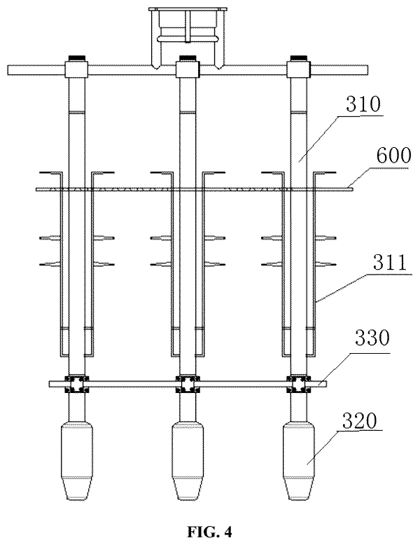

As shown in FIG. 3, the electrostatic rotary cup spray gun includes a gun barrel 310 and a gun head 320 which are connected with each other and mounted coaxially. An insulating gun holster 311 sleeves the gun barrel 310. An insulating waterproof cap 312 is arranged on the insulating gun holster 311. The electrostatic rotary cup spray gun 300 is a leakage point which needs to be protected emphatically, and all components connected with the gun body of the electrostatic rotary cup spray gun 300 are made of highly insulating materials (the Ransburg resistance is greater than 1.5 GΩ). Because the spray head is internally connected with a high-voltage negative electrode (the voltage is in the range of 0 to 100 KV), the glaze has been negatively charged before atomization. A shell of the spray gun and a glaze supply tube are made of a special high-purity antistatic Teflon material. The leakage rate is controlled within a safe range. That is to say, the insulating gun holster 311 is made of an insulating Teflon material to reduce glaze sticking. Two rows of electrostatic rotary cup spray guns 300 are arranged. There are three electrostatic rotary cup spray guns 300 in each row, and the three electrostatic rotary cup spray guns 300 are connected by a connecting rod, as shown in FIG. 4.

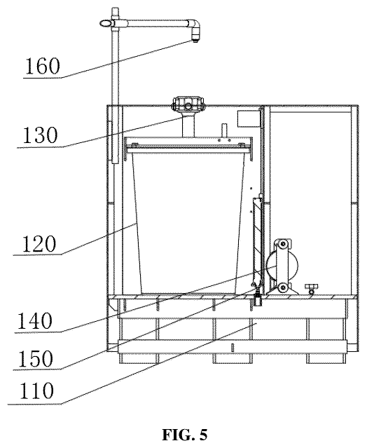

In one implementation method, as shown in FIG. 5, the glaze storage and adjustment device 100 includes an isolation platform 110, a glaze storage barrel 120, a first stirrer 130, a first conveying pump 140, a first discharge device 150 and a liquid level measuring device 160. The glaze storage barrel 120 is arranged on the isolation platform 110 and used for storing glaze. The first stirrer 130 is arranged in the glaze storage barrel 120 and used for stirring the glaze in the glaze storage barrel 120. The first conveying pump 140 is arranged on the isolation platform 110 and used for conveying the glaze to the transfer isolation glaze barrel 220. The first discharge device 150 is arranged on the isolation platform 110 and used for discharging static electricity generated by the glaze storage barrel 120. The liquid level measuring device 160 is arranged above the glaze storage barrel 120 and used for measuring the liquid level of the glaze storage barrel 120.

Specifically, the glaze storage barrel 120 serves as a container for receiving and storing finished glaze and is equipped with a stirring and anti-static device. When the glaze storage barrel 120 is short of glaze, the glaze supply tube is automatically disconnected from the glaze storage barrel 120, and the glaze tube is suspended to completely isolate static electricity. At the same time, the glaze storage barrel 120 is actively grounded to release residual static electricity, so as not to leak electricity during glazing. The first stirrer 130 is a pneumatic stirrer, and the rotating speed is controlled by a pressure regulating valve to prevent precipitation. The liquid level measuring device 160 is used for measuring the liquid level to control the amount of glaze in the barrel and the glazing time. The first discharge device 150 uses cylinder conduction discharge to control electric leakage. The glaze in the glaze storage barrel 120 is conveyed to the transfer isolation barrel through an electrostatic tube by the first conveying pump 140.

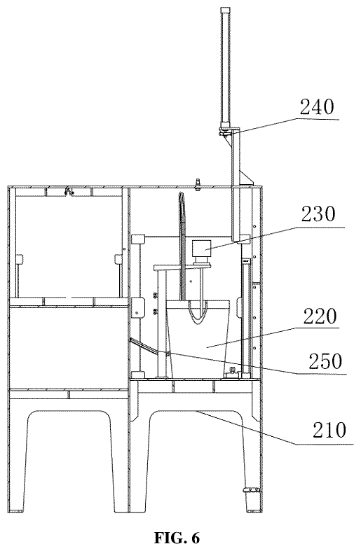

In one embodiment, as shown in FIG. 6, the transfer isolation device 200 includes an isolation workbench 210, a transfer isolation glaze barrel 220, a second conveying pipe 250, a second stirrer 230 and a second discharge device 240. The transfer isolation glaze barrel 220 is arranged on the isolation workbench 210 and used for receiving the glaze conveyed by the first conveying pump 140. The second conveying pipe 250 is connected with the transfer isolation glaze barrel 220 and used for conveying the glaze to the electrostatic rotary cup spray gun 300. The second stirrer 230 is arranged in the transfer isolation glaze barrel 220 and used for stirring the glaze in the transfer isolation glaze barrel 220. The second discharge device 240 is arranged on the isolation workbench 210 and used for discharging static electricity generated by the transfer isolation glaze barrel 220.

The transfer isolation glaze barrel 220 must be glazed for a long period of time in the continuous production process, and glaze lack is not allowed. The transfer isolation glaze barrel 220 is equipped with a small stirring and radar liquid level measuring device, and the liquid level fluctuates within a certain range through electronic control. Specifically, the second stirrer 230 is a pneumatic stirrer, and the rotating speed is controlled by a pressure regulating valve to prevent precipitation. The liquid level measuring device 160 is used for measuring the liquid level to control the amount of glaze in the barrel and the glazing time. The second discharge device 240 uses cylinder conduction discharge to control electric leakage. The glaze in the transfer isolation glaze barrel 220 is conveyed to the electrostatic rotary cup spray gun 300 through an electrostatic tube by the second conveying pipe 250.

In an implementation method, the glaze storage barrel 120 and the transfer isolation glaze barrel 220 are made of PA insulating materials, and the isolation platform 110 and the isolation workbench 210 are made of ABS engineering plastics. Specifically, the glaze barrel is made of high-strength PA insulating materials, and the isolation platform 110 and the isolation workbench 210 are made of ABS engineering plastics for insulation.

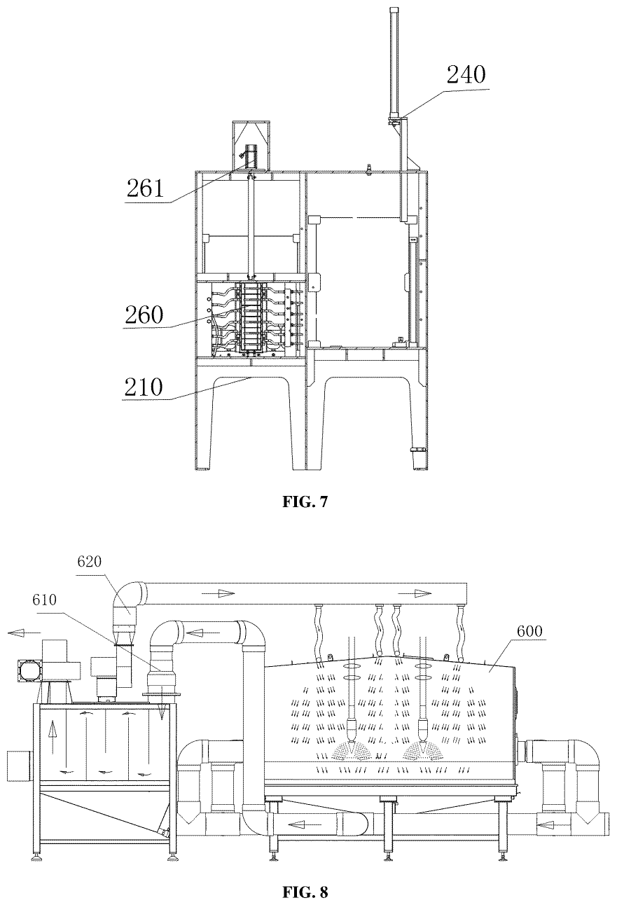

In an embodiment, as shown in FIG. 7, the transfer isolation device 200 also includes a roller pump 260. The roller pump 260 is connected with the second conveying pipe 250 and used for supplying the glaze in the transfer isolation glaze barrel 220 to the electrostatic rotary cup spray gun 300 through the second conveying pipe 250. The roller pump 260 is connected with the PLC intelligent controller 400. Specifically, each electrostatic rotary cup spray gun 300 is individually equipped with a miniature oil-free dry vortex roller pump 260 to pump glaze, and the flow rate is digitally adjusted on a control panel in the range of 0 to 1.5 L, so that the glazing amount of the body is conveniently adjusted.

The roller pump 260 is composed of three parts, such as a driver 261, a pump head and a hose, which can be combined and switched separately. The roller pump 260 includes the following advantages: firstly, roller pump is pollution-free, fluid is isolated in a pump tube and is not in contact with the pump: secondly, the roller pump is high in sealing performance and self-priming ability to prevent backflow: thirdly, the maintenance is simple, there is no valve or seal, and the pump tube can be quickly replaced: fourthly, the roller pump has the ability of conveying the same flow in both directions, so that liquid in the pipeline and spray gun can flow back when cleaning and replacing, and cannot block the pipe because of precipitation: fifthly, dry operation is not affected to prevent wear when empty barrels are empty: sixthly, the pipelines run independently, when the driving force is sufficient, only a pump head and pipelines need to be added, other equipment or driver do not need to be added, and one or more pipelines can be added at any time; and seventhly, the roller pump is high in precision, stable in flow per unit time and small in fluctuation during long-term operation. Moreover, the maintenance cost of the roller pump 260 is low. The traditional gear pump is a positive displacement pump, and is composed of two gears, a pump body and an end cover. The traditional gear pump has the following main shortcomings: firstly, the end cover and the grooves between teeth of the gear constitute many fixed sealed working chambers, and the pump can only be used as a quantitative pump: secondly, gears are easy to wear: thirdly, parts are poor in interchangeability and not easy to repair after wear; and fourthly, the pump is easy to leak.

In one implementation method, as shown in FIG. 1, the electrostatic spraying equipment also includes an electrostatic glaze spraying cabinet 600, a driving mechanism 700 and an air compressor 800. The electrostatic rotary cup spray gun 300 is arranged in the electrostatic glaze spraying cabinet 600. The driving mechanism 700 is arranged above the electrostatic glaze spraying cabinet 600, connected with the electrostatic rotary cup spray gun 300, and used for driving the electrostatic rotary cup spray gun 300 to move. The driving mechanism 700 is also connected with the PLC intelligent controller 400.

The air compressor 800 is internally provided with a temperature and humidity control air conditioning control module and a full-automatic cleaning control module. The air compressor 800 is used for providing a high-pressure air source and connected with the electrostatic rotary cup spray gun 300. That is to say, the air compressor 800 is specifically a voltage-stabilized air source with a temperature and humidity control air conditioning control function module and a full-automatic cleaning control module.

A glazing line passes through a barrel inside the electrostatic glaze spraying cabinet 600, and the body to be glazed runs on the glazing line. In order to prevent excessive dust in the spraying process, all spray guns and bodies are placed in the electrostatic glaze spraying cabinet 600 during normal operation, and most atomized glaze droplets are controlled inside the box to be recovered so as to minimize the influence of the electrostatic glaze spraying cabinet 600 on electrostatic glaze droplets. Six electrostatic rotary cup spray guns 300 are arranged in the electrostatic glaze spraying cabinet 600 in two rows. There are three electrostatic rotary cup spray guns in each row.

In an embodiment, the electrostatic glaze spraying cabinet 600 includes an upper cabinet body and a lower cabinet body which can be detachably connected. The upper cabinet body is made of insulating plastics, and the lower cabinet body is made of stainless steel.

The upper cabinet body is made of removable and integrated molding insulating thickened HDPE plastics and other molding materials. Specifically, the electrostatic glaze spraying cabinet 600 is composed of upper and lower parts. The upper part is an upper cabinet body, and is made of removable and integrated molding insulating HDPE plastics and other molding materials. The lower part is a lower cabinet body, and is made of stainless steel material. The two parts are installed and butted through clamping grooves.

The upper cabinet body is made of insulating materials, so that the adsorption of electrostatic atomized particles can be greatly reduced, the non-orientation, rebound and drift of atomized particles in the isolation cabinet body can be effectively reduced, the glaze dropping phenomenon on the top of the glaze cabinet can be reduced, the probability of electrostatic leakage of related connecting components can be reduced, and the utilization rate of glaze can be improved. The lower cabinet is made of conductive metal materials. After grounding, electrostatic atomized particles move downward, so that the probability of glaze dropping and electric leakage can also be reduced, and the utilization rate of glaze is improved.

In an embodiment, the electrostatic spraying equipment also includes a glaze recycle disc 900. The glaze recycle disc is arranged in the electrostatic glaze spraying cabinet 600 and placed under the glaze line to recycle atomized glaze. Due to the space between the bodies and the left-and-right swing of the spray gun, some glaze cannot fall on the surface of the body in the production process. In order to prevent glaze from being wasted, a stainless steel metal recycle disc is arranged below the glaze line. The glaze recycle disc 900 is a metal recycle disc.

The glaze recycle disc 900 can collect most of atomized glaze through grounding and sieve to the next process, and the downward movement of electrostatic atomized particles can be strengthened to green bricks, so that the utilization rate of glaze is improved, the atomized glaze particles are prevented from rebounding upward to the spray gun and the gun barrel, the probability of electrostatic leakage of glaze dropping on the top of the glaze cabinet and related connecting components is reduced, and the utilization rate of glaze is improved.

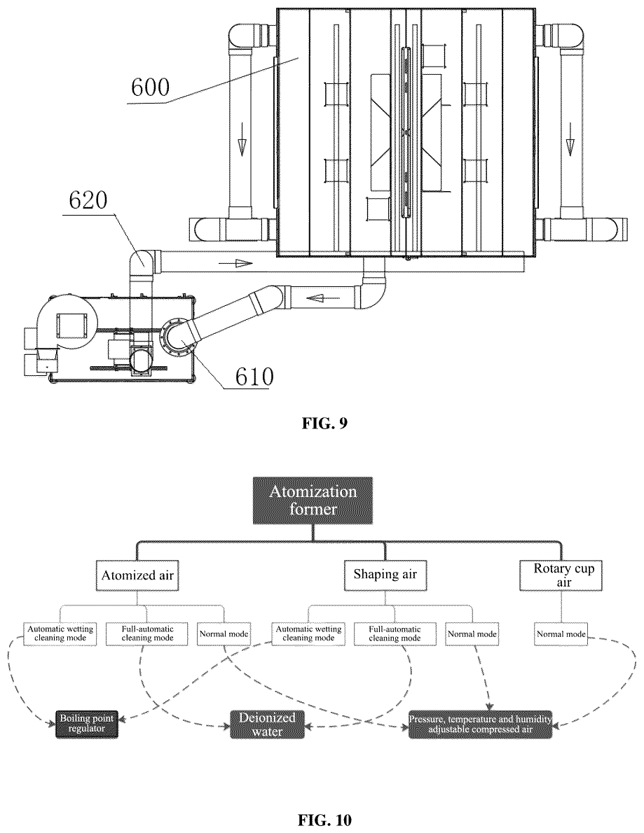

As shown in FIG. 8 and FIG. 9, the electrostatic spraying equipment in the present disclosure also includes a glaze cabinet internal pressure adjustment device 620 and a glaze cabinet dust removal device 610. The glaze cabinet internal pressure adjustment device 620 realizes reasonable and balanced airflow distribution in the glaze cabinet in the airflow pressure direction from top to bottom at four port steps downward. The glaze cabinet dust removal device 610 further recycles glaze dust in the glaze cabinet, and the overall flow of electrostatic atomized particles to working parts is facilitated, so that the rebound of airflow is reduced, and the reduction of production process defects such as glaze dripping, dirty slag falling and electric leakage is ensured.

The electrostatic rotary cup spray gun 300 is an internal electrostatic spray gun, and is externally connected with four parts such as a control circuit, a high-voltage circuit, an air hose and a glaze slurry hose. The air hose has several functional modules of an atomizing air module, a rotary cup air module and a shaping air module. Each module is connected with the voltage-stabilized air source of the device with a temperature and humidity control air conditioning control function and the module device with an automatic cleaning control function so as to realize the adjustment of various functions and technical requirements.

As shown in FIG. 10, the atomizing air module and the shaping air module can be set in a full-automatic boiling point regulator filling mode, a full-automatic deionized water cleaning mode, a pressure, temperature and humidity adjustable compressed air mode through electronic valve setting program, and three working modes, such as an automatic wetting cleaning mode, a full-automatic cleaning mode and a normal mode are switched, so that online full-automatic cleaning of accumulated glaze on rotary cup glaze vanes is realized.

The electrostatic spraying equipment in the present disclosure also includes a recycle barrel. The recycle barrel is connected with the glaze recycle disc 900. After sieving, the glaze slurry is stored in the recycle barrel. Because of water loss in the spraying process, the glaze slurry is used after the proportion needs to be calculated again, so that the glaze loss can be greatly reduced.

The equipment in the present disclosure fully considers high requirements of water-based glaze on insulation, and the shell of the spray gun and the glaze supply tube are made of special high-purity antistatic Teflon material to control the leakage rate within a safe range. Box components on the glaze cabinet are made of removable and insulated thickened HDPE plastic integrated molding material to reduce the influence of an isolation box on the glaze electrostatic fog droplets: a micropump is configured to supply glaze to realize digital continuous adjustment of glazing amount. The PLC intelligent controller realizes digital control of swing amplitude and frequency of the spray gun to ensure that the atomized glaze is evenly distributed on the surface of the body. The high-voltage electrostatic generator adopts the built-in voltage doubling automatic protection circuit design, so that a strong spark phenomenon caused by short-distance electric leakage can be effectively prevented, and the machine is automatically protected and stops when the leakage current reaches the set protection value. Through the glaze recycle disc, the utilization rate of glaze can be improved. Through anti-blockage design of a glaze road, the time interval of periodic cleaning can be prolonged.

The present disclosure also provides a spraying method based on the electrostatic spraying equipment, including the following steps:
step S100, preparing all-water electrostatic working slurry;
step S200, conveying the all-water electrostatic working slurry to a transfer isolation device through a glaze storage and adjustment device, and adjusting the all-water electrostatic working slurry according to adjusting index requirements in the transfer isolation device;
step S300, starting a PLC intelligent controller and a high-voltage electrostatic generator, controlling an electrostatic rotary cup spray gun to swing for glazing according to working glazing amount;
step S400, after glazing, turning off the high-voltage electrostatic generator and discharging; and
step S500, cleaning pipelines in the electrostatic spraying equipment.

Specifically, the formula of the all-water electrostatic working slurry includes a dry-based component, a wet-based component and a solvent. The dry-based component is ultra-fine ceramic glaze powder composed of a basic building ceramic formula according to 100 parts by weight. The wet-based component includes the following components to form a soft precipitate in parts by weight: 0.3-0.6 parts of a rheological additive and a dispersant: 0.1-1 parts of a suspension stabilizer: 0.1-1 part of a surface active solubilizer: 40-50 parts of deionized water and 0-5 parts of a surface tension regulator; and 1-3 parts of an anti-aging precipitant. The solvent is deionized water or tap water, and a water-based suspending agent and one or more boiling point regulators are appropriately added to adjust the formula to the working specific gravity and meet the specific technical index requirements.

After the dry-based component and the wet-based component are put into a conventional ball mill and milled to the required fineness, a solvent is further added and adjusted to the working specific gravity, and technical indexes such as boiling point and suspension should be considered at the same time.

Specifically, the specific processing process of the all-water electrostatic working slurry includes the following steps:

step A1, according to the proportion of the dry-based component and the wet-based component, weighing ceramic raw material powder to be added into a ball mill, adding proper amount of water respectively according to the proportion, mixing evenly, grinding for 6-12 h in a large-scale intermittent ball mill until a 325-mesh screen is completely passed to prepare water-based glaze slurry:

step A2, ensuring that the original glaze slurry particle diameter D97 of the obtained water-based glaze slurry is 10-20 μm, the pH is 7-8, the specific gravity is 1.75-1.85, and the flow rate is 60-90 seconds:

step A3, adjusting the original glaze slurry to the working specific gravity by using deionized water, the water-based suspending agent and one or more boiling point regulators in a working bucket and meeting the specific technical index requirements to obtain environment-friendly all-water electrostatic glaze slurry: the physical and chemical index requirements of the all-water electrostatic working slurry are specifically as follows: D97 is 10-20 μm, the pH is 7-8, the specific gravity is 1.20-1.50, the flow rate is 11-13 seconds, the thixotropic coefficient is less than 1.10, the viscosity is 10-30 mPa's, the resistivity is less than or equal to 1.2 MΩ·cm, the boiling point is 100-105 degrees centigrade, and the surface tension is 30-40 dyne/cm.

The suspension requirements are as follows: the working glaze slurry is placed in a 100 mL glass test tube at room temperature of 25 degrees centigrade, and less than 5 mL of soft precipitation is placed for 48 hours, and there is no hard precipitation after 7 days.

The proportion of spherical stone with the diameters of 8 mm, 16 mm and 20 mm is 3:5:2 respectively.

In an implementation method, the step S100 specifically includes the following steps:
step S110, determining a ball-milling formula of water-based glaze according to current temperature and humidity information, and throwing balls according to the ball-milling formula of water-based glaze to prepare original glaze;
step S120, determining an additive formula, adjusting parameters of the original glaze according to the additive formula to reach working physical and chemical indexes and working specific gravity, and obtaining the all-water electrostatic working slurry after sieving and removing iron.

Specifically, according to the changes of weather, temperature and humidity in different seasons, a ball milling formula of water-based glaze is reasonably determined to prepare the original glaze by throwing balls. The glaze particle size, suspension, rheology and other properties are adjusted to ensure that the glaze slurry has good suspension and rheological properties and meets the requirements of performance parameters. The additive formula is determined, the specific gravity, conductivity, viscosity, surface tension, boiling point, glaze temperature and other parameters of glaze slurry are adjusted to meet the requirements of working physical and chemical indexes to obtain all-water electrostatic working slurry after sieving and removing iron.

The step S200 specifically includes the following steps:
step S210, conveying the all-water electrostatic working slurry to a glaze storage barrel of the glaze storage and adjustment device;
step S220, conveying the all-water electrostatic working slurry in the glaze storage barrel to a transfer isolation glaze barrel of a transfer isolation device, and adjusting the all-water electrostatic working slurry according to adjusting index requirements in the transfer isolation device;

Specifically, the all-water electrostatic working slurry is pumped into a glaze storage barrel by a glaze pump, and then a pneumatic diaphragm pump is started and pumped into a transfer isolation glaze barrel. Through the adjusting index requirements of surface tension, viscosity, thixotropy and suspension, the stability of glaze conveying is ensured without blocking pipelines. Thus, it is ensured that the spray head cannot be blocked when the continuous electrostatic glazing production of the production line stops for more than 24 hours.

The step S300 specifically includes the following steps:
step S310, starting a PLC intelligent controller, controlling an electrostatic rotary cup spray gun to swing according to preset swing and preset frequency;
step S320, conveying the all-water electrostatic working slurry to the electrostatic rotary cup spray gun through an electrostatic spray gun pipeline, and simultaneously carrying out glaze cabinet dust removal and internal pressure adjustment;
step S330, starting a high-voltage electrostatic generator, and carrying out temperature and humidity control, and adjusting the glazing amount of the electrostatic rotary cup spray gun to working glazing amount by adjusting the speed of a belt on a glaze line and the rotating speed of a roller pump on the transfer isolation device;
step S340, in the spraying process, according to different production process requirements, switching an automatic wetting cleaning mode, a full-automatic cleaning mode and a normal mode for rotary cup vane glaze accumulation.

Specifically, the PLC intelligent controller is started to control two groups of electrostatic spray guns to swing left and right, and the swing amplitude and frequency are digitally adjustable to ensure that the atomized glaze is evenly distributed on the surface of the body. An electrostatic isolating switch of a main electrical control cabinet is turned on, and then a glaze rolling pump is started to extract the all-water electrostatic working slurry to an electrostatic spray gun pipeline system to be kept on the working liquid level.

A glaze cabinet dust removal device and a glaze cabinet internal pressure adjustment device are started. By controlling the airflow pressure and a dust removal fan in the glaze cabinet, a more reasonable and balanced airflow is ensured in the glaze cabinet, and the distribution, flow quantity and drying and evaporation rate of an atomized water-based glaze film in the rotary vanes of the spray gun, a gun body and gun rack connecting mechanism and the glaze cabinet are effectively controlled. Electrostatic spraying particles flow to working parts as a whole, so that airflow rebound is reduced, the utilization rate of glaze is improved, and raise dust is reduced by recycling the glaze in time.

The high-voltage electrostatic generator in the main electrical control cabinet is started.

The temperature and humidity control air conditioning control function module is started, and an atomized air, shaping air and rotary cup air source from an air pressure source of large-scale production is controlled to meet the requirements of working index parameters. Accurate adjustment of electrostatic atomization effect is realized by controlling high-voltage electrostatic voltage, pressure and flow opening of atomized air, shaping air and rotary cup air so as to ensure continuous glaze spraying atomization effect of the rotary cup.

The belt speed and glaze rolling pump revolution speed are adjusted, and the glazing amount is adjusted to the working glazing amount.

In the spraying process, the shaping air pressure or atomizing air pressure module can switch three working modes, such as an automatic wetting cleaning mode, an automatic cleaning mode and a normal mode for rotary cup vane glaze accumulation, according to different production process requirements through electronic valve setting program, so that real-time online cleaning of glaze accumulation pollution of rotating cups is realized, and the electrostatic glazing effect is ensured. By blowing glaze slag and dropping glaze with a compressed air gun every other hour, and the glaze cabinet is thoroughly cleaned every production shift, so that it is ensured that the defects such as glaze dropping, dropping dirt and slag, and electric leakage in the production process cannot be caused.

The step S500 specifically includes the following steps:
step S510, replacing the glaze in the transfer isolation glaze barrel of the transfer isolation device into clean liquid, and starting the full-automatic cleaning mode to clean all pipelines;
step S520, turning off the roller pump on the transfer isolation device.

Specifically, when the glazing work is finished and the machine stops, the high-voltage electrostatic generator is turned off first, and the electrostatic isolating switch of the main electric control cabinet is turned on for discharge. The glaze in the transfer isolation glaze barrel is changed to clean tap water, and the automatic cleaning mode is started to clean all pipelines. The PLC intelligent controller turns off the glaze cabinet dust removal device and the glaze cabinet internal pressure adjustment device. The roller pump and the pneumatic diaphragm pump are turned off, and finally the glaze cabinet is cleaned.

In this way, the particle size range of the traditional building ceramic glaze processing can meet the requirements of the equipment in the present disclosure on the ball milling fineness of the electrostatic glazing glaze, so that the difficulty of the ball milling processing is reduced, and the requirements can be met by adopting ordinary configuration of a ball mill and ball stone. The whole electrostatic glazing process is environmentally friendly, and meets the requirements of VOCs (Volatile Organic Chemicals) emission, so that the glaze processing cost is reduced, and the competitiveness of products is improved.

The water-based formula in the present disclosure adjusts main working indexes such as boiling point and suspension through comprehensive combination of a boiling point regulator, water-based suspension and various rheological additives to ensure electrostatic atomization and rheological performance of water-based glaze. Meanwhile, by controlling the working temperature and humidity of atomized air, shaping air and rotary cup air from the air pressure air source and setting procedures through electronic valves, the switching between three working modes such as an automatic wetting cleaning mode, a full-automatic cleaning mode and a normal mode for rotary cup vane glaze accumulation is carried out according to different production process requirements, it is ensured that rotary cup vanes are free of glaze pollution due to accumulation when the electrostatic rotary cup works continuously, so that adverse effects on glaze spraying atomization effect cannot be caused. The industrial application effect of electrostatic glaze spraying technology in the building ceramic industry is achieved for the first time, and the environment-friendly all-water thin-layer glaze with the glaze amount of 0-120 g/m² and the average atomized particle diameter D90 of less than 0.15 mm is uniformly atomized and coated, so that the industry bottleneck that water-based glaze is difficult to be applied in traditional glazing equipment within the working glaze amount range is solved.

In conclusion, the present disclosure provides electrostatic spraying equipment and an electrostatic spraying method. The electrostatic spraying equipment includes a glaze storage and adjustment device used for storing and stirring glaze, a transfer isolation device connected with the glaze storage and adjustment device and used for receiving the glaze in the glaze storage and adjustment device, an electrostatic rotary cup spray gun connected with a transfer isolation glaze barrel and used for receiving the glaze in the transfer isolation glaze barrel and spraying the glaze to a body to be glazed on a glaze line, a PLC intelligent controller connected with the glaze storage and adjustment device, the transfer isolation device and the electrostatic rotary cup spray gun and used for controlling the glaze storage and adjustment device, the transfer isolation device and the electrostatic rotary cup spray gun, and a high-voltage electrostatic generator connected with the electrostatic rotary cup spray gun and used for electrifying the electrostatic rotary cup spray gun. The glaze is stored and stirred through the glaze storage and adjustment device. The glaze is conveyed to the electrostatic rotary cup spray gun by the transfer isolation device. Uniform atomization coating of all-water thin-layer glaze on a glazed body of a large-size product in the building ceramic industry is realized through the electrostatic rotary cup spray gun, so that the industrial technical problems of rotary cup glaze accumulation, glaze dropping in a glaze cabinet, dropping dirt and dropping slag and electric leakage when the traditional water-based electrostatic spraying industry is applied to the building ceramic field across industries are solved.

It should be understood that the application of the present disclosure is not limited to the examples described above, and these modifications or variations can be made according to the above description for those skilled in the art, all of which are intended to fall within the scope of the appended claims.

1-10. (canceled)

11. Electrostatic spraying equipment, comprising:
a glaze storage and adjustment device, the glaze storage and adjustment device configured for storing and stirring glaze;
a transfer isolation device, the transfer isolation device connected with the glaze storage and adjustment device and configured for receiving the glaze in the glaze storage and adjustment device;
an electrostatic rotary cup spray gun, the electrostatic rotary cup spray gun connected with a transfer isolation glaze barrel and configured for receiving the glaze in the transfer isolation glaze barrel and spraying the glaze to a body to be glazed on a glaze line;
a programmable logic controller (PLC) intelligent controller, the PLC intelligent controller connected with the glaze storage and adjustment device, the transfer isolation device and the electrostatic rotary cup spray gun; and
a high-voltage electrostatic generator, the high-voltage electrostatic generator connected with the electrostatic rotary cup spray gun and configured for electrifying the electrostatic rotary cup spray gun.

12. The electrostatic spraying equipment according to claim 11, wherein the electrostatic rotary cup spray gun comprises a gun barrel and a gun head which are connected with each other and mounted coaxially, an insulating gun holster sleeves the gun barrel, and an insulating waterproof cap is arranged on the insulating gun holster.

13. The electrostatic spraying equipment according to claim 11, wherein the glaze storage and adjustment device comprises:
an isolation platform;
a glaze storage barrel, the glaze storage barrel being arranged on the isolation platform and configured for storing glaze;
a first stirrer, the first stirrer being arranged in the glaze storage barrel and configured for stirring the glaze in the glaze storage barrel;
a first conveying pump, the first conveying pump being arranged on the isolation platform and configured for conveying the glaze to the transfer isolation glaze barrel;
a first discharge device, the first discharge device being arranged on the isolation platform and configured for discharging static electricity generated by the glaze storage barrel;
a liquid level measuring device, arranged above the glaze storage barrel and configured for measuring the liquid level of the glaze storage barrel;
the transfer isolation device comprises:
an isolation workbench;
a transfer isolation glaze barrel, the transfer isolation glaze barrel arranged on the isolation workbench and configured for receiving the glaze conveyed by the first conveying pump;
a second conveying pipe, the second conveying pipe connected with the transfer isolation glaze barrel and configured for conveying the glaze to the electrostatic rotary cup spray gun;
a second stirrer, the second stirrer arranged in the transfer isolation glaze barrel and configured for stirring the glaze in the transfer isolation glaze barrel; and
a second discharge device, the second discharge device arranged on the isolation workbench and configured for discharging static electricity generated by the transfer isolation glaze barrel.

14. The electrostatic spraying equipment according to claim 13, wherein the glaze storage barrel and the transfer isolation glaze barrel are made of PA (Polyamide) insulating materials, and the isolation platform and the isolation workbench are made of ABS (Acrylonitrile Butadiene Styrene) engineering plastics.

15. The electrostatic spraying equipment according to claim 13, wherein the transfer isolation device also comprises:
a roller pump, the roller pump connected with the second conveying pipe and configured for supplying the glaze in the transfer isolation glaze barrel to the electrostatic rotary cup spray gun through the second conveying pipe, and the roller pump connected with the PLC intelligent controller.

16. The electrostatic spraying equipment according to claim 11, wherein the electrostatic spraying equipment also comprises:
an electrostatic glaze spraying cabinet, the electrostatic rotary cup spray gun arranged in the electrostatic glaze spraying cabinet;
a driving mechanism, the driving mechanism arranged above the electrostatic glaze spraying cabinet, connected with the electrostatic rotary cup spray gun, and configured for driving the electrostatic rotary cup spray gun to move, and the driving mechanism also connected with the PLC intelligent controller; and
an air compressor, the air compressor internally provided with a temperature and humidity control air conditioning control module and a full-automatic cleaning control module, the air compressor configured for providing a high-pressure air source and connected with the electrostatic rotary cup spray gun.

17. The electrostatic spraying equipment according to claim 16, wherein the electrostatic glaze spraying cabinet comprises an upper cabinet body and a lower cabinet body which can be detachably connected; and the upper cabinet body is made of HDPE (High-density Polyethylene) plastic insulating plastics, and the lower cabinet body is made of stainless steel.

18. The electrostatic spraying equipment according to claim 16, wherein the electrostatic spraying equipment also comprises:
a glaze recycle disc, the glaze recycle disc arranged in the electrostatic glaze spraying cabinet and placed under the glaze line to recycle atomized glaze.

19. An electrostatic spraying method realized based on the electrostatic spraying equipment according to claim 11, comprising the following steps:
preparing all-water electrostatic working slurry;
conveying the all-water electrostatic working slurry to a transfer isolation device through a glaze storage and adjustment device;
starting a PLC intelligent controller and a high-voltage electrostatic generator, controlling an electrostatic rotary cup spray gun to swing for glazing according to working glazing amount;
after glazing, turning off the high-voltage electrostatic generator and discharging; and
cleaning pipelines in the electrostatic spraying equipment.

20. The electrostatic spraying method according to claim 19, wherein the step of preparing all-water electrostatic working slurry specifically comprises the following steps:
determining a ball-milling formula of water-based glaze according to current temperature and humidity information, and throwing balls according to the ball-milling formula of water-based glaze to prepare original glaze;
determining an additive formula, adjusting parameters of the original glaze according to the additive formula to reach working physical and chemical indexes and working specific gravity, and obtaining the all-water electrostatic working slurry after sieving and removing iron;
the step of conveying the all-water electrostatic working slurry to a transfer isolation device through a glaze storage and adjustment device specifically comprises the following steps:
conveying the all-water electrostatic working slurry to a glaze storage barrel of the glaze storage and adjustment device;
conveying the all-water electrostatic working slurry in the glaze storage barrel to a transfer isolation glaze barrel of the transfer isolation device;
the step of starting a PLC intelligent controller and a high-voltage electrostatic generator, controlling an electrostatic rotary cup spray gun to swing for glazing according to working glazing amount specifically comprises the following steps:
starting a PLC intelligent controller, controlling an electrostatic rotary cup spray gun to swing according to preset swing amplitude and preset frequency;
conveying the all-water electrostatic working slurry to the electrostatic rotary cup spray gun through an electrostatic spray gun pipeline, and simultaneously carrying out glaze cabinet dust removal and internal pressure adjustment;
starting a high-voltage electrostatic generator, and carrying out temperature and humidity control, and adjusting the glazing amount of the electrostatic rotary cup spray gun to working glazing amount by adjusting the speed of a belt on a glaze line and the rotating speed of a roller pump on the transfer isolation device;
in the spraying process, according to different production process requirements, switching an automatic wetting cleaning mode, a full-automatic cleaning mode and a normal mode for rotary cup vanes by an air compressor;
the step of cleaning pipelines in the electrostatic spraying equipment specifically comprises the following steps:
replacing the glaze in the transfer isolation glaze barrel of the transfer isolation device into clean liquid, and starting the full-automatic cleaning mode to clean all pipelines; and
turning off the roller pump on the transfer isolation device.
